(19) United States
(12) Patent Application Publication
(10) Pub. No.: US 2026/0252968 A1
(43) Pub. Date: Aug. 27, 2026

(54) DEVICE AND COMPUTER IMPLEMENTED METHOD FOR MULTI-MODAL FOUNDATION MODEL TRAINING

(71) Applicant: Robert Bosch GmbH, Stuttgart (DE)

(72) Inventors: Nian Hua, Magstadt (DE); Ivan Batalov, Pittsburgh, PA (US); Sascha Wirges, Buehl (DE)

(21) Appl. No.: 19/547,897

(22) Filed: Feb. 24, 2026

(30) Foreign Application Priority Data
Feb. 27, 2025 (DE) 10 2025 107 484.4

(51) Int. Cl. G06N 20/00

(52) U.S. Cl. CPC G06N 20/00

(57) ABSTRACT

A device and computer implemented method for multi-modal foundation model training. The method includes: providing a set of inputs of a first modality and a set of inputs of a second modality, the set of inputs of the first modality including a sequence of the inputs of the first modality representing a movement of a body in the real world, the set of inputs of the second modality including a sequence of the inputs of the second modality representing the same movement of the body in the real world; determining for inputs to the multi-modal foundation model that include different combinations of one input of the set of inputs of the first modality and one input of the set of inputs of the second modality an output of the multi-modal foundation model respectively; and training the multi-modal foundation model.

### CROSS REFERENCE

The present application claims the benefit under 35 U.S.C. § 119 of Germany Patent Application No. DE 10 2025 107 484.4 filed on Feb. 27, 2025, which is expressly incorporated herein by reference in its entirety.

### FIELD

The present disclosure relates to a device and a computer implemented method for multi-modal foundation model training.

### BACKGROUND INFORMATION

Multi-modal foundation models combine multiple modalities into a single embedding space.

An example for a multi-modal foundation model is “ImageBind: One Embedding Space To Bind Them All” (arXiv: 2305.05665).

### SUMMARY

According to an example embodiment of the present disclosure, a computer implemented method for multi-modal foundation model training comprises providing a set of inputs of a first modality and a set of inputs of a second modality, wherein the set of inputs of the first modality comprises a sequence of the inputs of the first modality representing a movement of a body in the real world, wherein the set of inputs of the second modality comprises a sequence of the inputs of the second modality representing the same movement of the body in the real world, determining for inputs to the multi-modal foundation model that comprise different combinations of one input of the set of inputs of the first modality and one input of the set of inputs of the second modality an output of the multi-modal foundation model respectively, and training the multi-modal foundation model depending on a loss that comprises an in particular weighted loss term for the outputs respectively. For two modalities the loss is a pairwise loss. Such pairwise losses can include contrastive loss as CLIP loss and SigLIP loss.

CLIP loss is described, for example, in “Learning Transferable Visual Models From Natural Language Supervision” (arXiv: 2103.00020v1).

SigLIP loss is described, for example, in “Sigmoid Loss for Language Image Pre-Training” (arXiv: 2303.15343v4).

The training requires training data, particularly high quality data that spans across multiple modalities.

For modalities that are not available as data captured in the real world, providing the set of inputs of the second modality may comprise determining the set of inputs of the second modality by synthetic data generation.

According to an example embodiment, the determining the set of inputs of the second modality by synthetic data generation may comprise determining the inputs of the second modality for example with a generative artificial intelligence depending on the inputs of the first modality or depending on captured data representing the movement of the body in the real world, or determining the set of inputs of the second modality in a simulation of the motion of the body, or determining the set of inputs rule based, or determining the set of inputs by combining these approaches.

The inputs of the first modality may comprise different digital images and/or audio sequences respectively. An example for the inputs of the first modality is video or audio footage of the movement of the body. The video footage may comprise the audio footage.

The inputs of the second modality may comprise values of a physical quantity, in particular an acceleration or velocity or yaw rate or pitch rate or roll rate of the body, wherein one input of the second modality comprises at least one value of the physical quantity. The video footage may come with sensor signals from at least one sensor that measured the physical quantity when filming the same movement of the body. An example for the inputs of the second modality is the values of the physical quantity that come with the video footage.

The inputs of the second modality may be determined by synthetic data generation depending on captured data representing the same movement of the body in the real world. The captured data may be sensor signals from sensors that measured the physical quantity that the second modality comprises or a different physical quantity during the same movement of the body that the first modality represents.

The inputs of the second modality may comprise text, wherein the text in the respective input describes the position or the part of the motion of the body that the respective input represents. An example for the text is a text description or caption of the video footage that comes with the video footage.

According to an example embodiment, the method may comprise providing a signal characterizing the movement of the body, in particular a signal comprising the first modality, providing a target pattern for the signal, providing a label associated with the target pattern, and wherein determining the text comprises matching a pattern of the signal to the target pattern, and determining the text to comprise the label. According to an example embodiment, a data structure comprises at least one data field for a set of inputs of a first modality and a set of inputs of a second modality, wherein the set of inputs of the first modality comprises a sequence of the inputs of the first modality representing a movement of a body in the real world, wherein the set of inputs of the second modality comprises a sequence of the inputs of the second modality representing the same movement of the body in the real world, wherein the data structure comprises at least one data field for outputs of the multi-modal foundation model determined for inputs to the multi-modal foundation model that comprise different combinations of one input of the set of inputs of the first modality and one input of the set of inputs of the second modality respectively, and wherein the data structure comprises at least one data field for the multi-modal foundation model and a loss that comprises an in particular weighted loss term for the outputs respectively.

According to an example embodiment, a device for multi-modal foundation model training comprises at least one processor and at least one memory, wherein the at least one memory stores instructions that, when executed by the at least one processor, cause the device to execute a method.

According to an example embodiment, a computer program may be provided, wherein the computer program comprises computer-readable instructions that, when executed by a computer, cause the computer to execute a method of the present disclosure.

Further examples are derivable from the following description and the figures.

### BRIEF DESCRIPTION OF THE DRAWINGS

FIG. 1 schematically depicts a device for multi-modal foundation model training, according to an example embodiment.

FIG. 2 depicts a flow chart comprising steps of a method for multi-modal foundation model training, according to an example embodiment.

### DETAILED DESCRIPTION OF EXAMPLE EMBODIMENTS

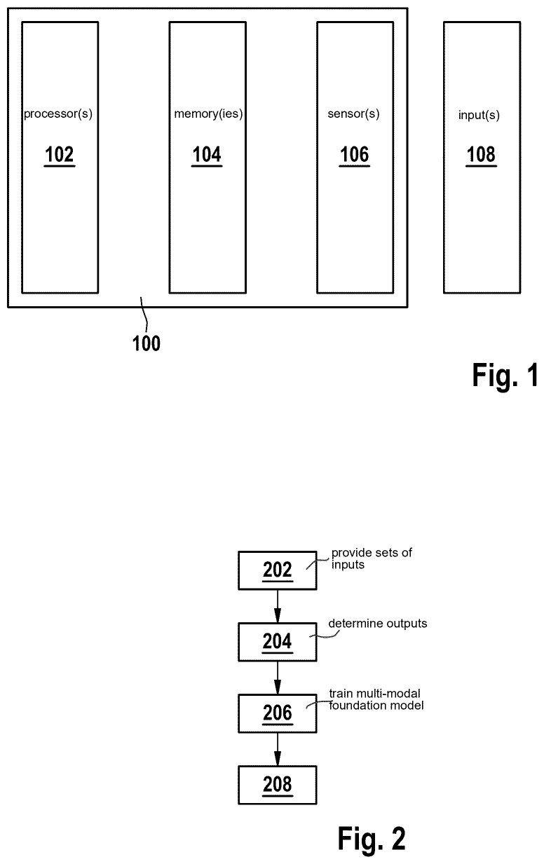

FIG. 1 schematically depicts a device 100 for multi-modal foundation model training, characterized in that the device 100 comprises at least one processor 102 and at least one memory 104.

The at least one memory 104 stores instructions that, when executed by the at least one processor, cause the device 100 to execute a method for multi-modal foundation model training.

The device 100 may comprise at least one sensor 106 or at least one input 108 for at least one sensor 106. An example for the at least one sensor 106 is a sensor, in particular a camera, for capturing a digital image. The digital image may be a video, radar, LiDAR, ultrasonic, motion, or thermal image.

An example for the at least one sensor 106 is an IMU or a microelectromechanical system (MEMS) sensors, in particular for capturing an acceleration or a velocity or a yaw rate or a nick rate or a roll rate.

An example for the at least one sensor 106 is an accelerometer, an odometer, a yaw rate sensor, a nick rate sensor, or a roll rate sensor.

An example for the at least one sensor 106 is a microphone for capturing audio data, in particular an audio sequence.

An example for the at least one sensor 106 is a health sensor, in particular a heartbeat sensor.

FIG. 2 depicts a flow chart comprising steps of the method.

The method comprises a step 202.

The step 202 comprises providing a set of inputs of a first modality and a set of inputs of a second modality.

The set of inputs of the first modality comprises a sequence of the inputs of the first modality representing a movement of a body in the real world.

The set of inputs of the second modality comprises a sequence of the inputs of the second modality representing the same movement of the body in the real world.

Providing the set of inputs of the second modality may comprise determining the set of inputs of the second modality by synthetic data generation.

The set of inputs of the second modality are for example determined with a generative artificial intelligence depending on the inputs of the first modality.

Determining the set of inputs of the second modality by synthetic data generation may comprise determining the inputs of the second modality depending on the inputs of the first modality.

Determining the set of inputs of the second modality by synthetic data generation may comprise determining the inputs of the second modality depending on captured data representing the movement of the body in the real world.

Determining the set of inputs of the second modality by synthetic data generation may comprise determining the set of inputs of the second modality in a simulation of the motion of the body.

The inputs of the first modality for example comprise different digital images respectively.

The digital images may be video, radar, LiDAR, ultrasonic, motion, or thermal images.

The inputs of the first modality for example comprise different audio sequences respectively.

The inputs of the first modality for example comprise different digital images and audio sequences respectively.

The inputs of the second modality for example comprise a physical quantity. Examples for the physical quantity are an acceleration or velocity or yaw rate or pitch rate or roll rate of the body.

For example, one input of the second modality comprises one value of the physical quantity. For example, one input of the second modality comprises values of the physical quantity.

The inputs of the second modality for example comprise text. The text in the respective input describes for example the position or the part of the motion of the body that the respective input represents.

According to an example, the text is determined depending on a signal characterizing the movement of the body. The signal may comprise the first modality. The signal may be captured by at least one sensor. The at least one sensor may be configured to capture an acceleration or velocity or yaw rate or pitch rate or roll rate of the body.

The text is determined for example depending on a target pattern for the signal, and depending on a label associated with the target pattern.

Determining the text comprises for example matching a pattern of the signal to the target pattern, and determining the text to comprise the label associated with the target pattern.

According to an example, the target pattern and the label are provided. A plurality of target pattern and labels associated to one of the target pattern respectively may be provided.

The method comprises a step 204.

The step 204 comprises determining outputs of the multi-modal foundation model depending on different inputs to the multi-modal foundation model.

The step 204 comprises determining inputs to the multi-modal foundation model that comprise different combinations of one input of the set of inputs of the first modality and one input of the set of inputs of the second modality.

The step 204 comprises an output of the multi-modal foundation model for an input to the multi-modal foundation model respectively.

The output for example comprises an embedding of the input of the first modality and an embedding of the second modality in a common embedding space.

The embedding of the input of the first modality is determined for example with a first encoder E1 of the multi-modal foundation model.

The embedding of the input of the second modality is determined for example with a second encoder E2 of the multi-modal foundation model.

The first encoder E1 is for example configured to output a normalized embedding for the input of the first modality.

The second encoder E2 is for example configured to output a normalized embedding for the input of the second modality.

An exemplary matrix M comprising the embedding's IᵢTSⱼ as elements ij of the matrix M is described for inputs I₁, I₂, I₃, . . . , I_{N} of an exemplary first modality I and inputs TS₁, TS₂, TS₃, . . . , TS_{N} of an exemplary second modality TS. The first modality I is image data, the second modality TS is multidimensional IMU data, i.e., data comprising a value of an Accelerometer, a Gyroscope, and a Magnetometer.

$$M = [ \begin{matrix}{I}_{1} {TS}_{1} & {I}_{1} {TS}_{2} & {I}_{1} {TS}_{3} & … & {I}_{1} {TS}_{N} \\ {I}_{2} {TS}_{1} & {I}_{2} {TS}_{2} & {I}_{2} {TS}_{3} & … & {I}_{2} {TS}_{2} \\ {I}_{3} {TS}_{1} & {I}_{3} {TS}_{2} & {I}_{3} {TS}_{3} & ⋯ & {I}_{2} {TS}_{3} \\ ⋮ & ⋮ & ⋮ & ⋮ & ⋮ \\ {I}_{N} {TS}_{1} & {I}_{N} {TS}_{2} & {I}_{N} {TS}_{3} & ⋯ & {I}_{N} {TS}_{N}\end{matrix} ]$$

The input to the multi-modal foundation model is not limited to inputs of two different modalities. The input to the multi-modal foundation model may comprise more than two inputs of different modalities. The input to the multi-modal foundation model may comprise more than one input of the same modality. The inputs of the same modality may stem from different sources. The inputs of the same modality may be captured by different sensors. At least of the inputs of the same modality may be captured by a sensor and at least one of the inputs may be generated by the synthetic data generation.

The method comprises a step 206.

The step 206 comprises training the multi-modal foundation model depending on a loss that comprises an in particular weighted loss term for the outputs respectively.

An exemplary loss for the first modality and the second modality comprises a loss term comprising the elements weight ij of the matrix M. The elements ij may be weighted by a weight Wᵢⱼ respectively. The loss is not limited to a pairwise loss.

The exemplary weighted loss L for the first modality and the second modality is for example:

$$L = {\sum }_{ij ∀ i , j} {w}_{ij} {L}_{ij}$$

wherein Lᵢⱼ is a loss function, e.g., Lᵢⱼ(Iᵢ, TSⱼ). The loss function comprises for example a distance between the embedding of the input of the first modality Iᵢ and the embedding of the input of the second modality TSⱼ of the pair Iᵢ, TSⱼ.

The weights wᵢⱼ may be given as hyperparameters or be trained.

The multi-modal foundation model is for example a sensor foundation model. In the sensor foundation model, one encoder is trained for IMU time series data and at least one encoder is trained with another modality. The sensor foundation model is trained to align the embedding of the encoder for IMU time series data with the embedding of the at least one other modality.

According to an example, image data and IMU data pairs are used to train the multi-modal sensor foundation model to align the embedding of the two modalities image and IMU.

The output of the sensor foundation model for an input of one modality is for example used for a task.

An example for the task is inferring an action from the input of one modality.

An example for the task is anomaly detection, e.g., detecting an anomaly when the distance between the embedding's determined for an input of the first modality and an input of the second modality that characterize the movement of the body at the same time or within a predetermined time interval exceeds a threshold.

A data structure may be provided. The data structure comprises at least one data field for a set of inputs of a first modality and a set of inputs of a second modality.

The set of inputs of the first modality comprises a sequence of the inputs of the first modality representing a movement of a body in the real world. The set of inputs of the second modality comprises a sequence of the inputs of the second modality representing the same movement of the body in the real world.

The data structure comprises at least one data field for outputs of the multi-modal foundation model determined for inputs to the multi-modal foundation model that comprise different combinations of one input of the set of inputs of the first modality and one input of the set of inputs of the second modality respectively.

The data structure comprises at least one data field for the multi-modal foundation model and a loss that comprises an in particular weighted loss term for the outputs respectively.

What is claimed is:

1. A computer implemented method for multi-modal foundation model training, the method comprising the following steps:
providing a set of inputs of a first modality and a set of inputs of a second modality, wherein the set of inputs of the first modality includes a sequence of the inputs of the first modality representing a movement of a body in the real world, and wherein the set of inputs of the second modality includes a sequence of the inputs of the second modality representing the same movement of the body in the real world;
determining for inputs to the multi-modal foundation model includes for each of different combinations of one input of the set of inputs of the first modality and one input of the set of inputs of the second modality, a respective output of the multi-modal foundation model respectively; and
training the multi-modal foundation model depending on a loss that includes a respective weighted loss term for each of the outputs.

2. The method according to claim 1, wherein the providing of the set of inputs of the second modality includes determining the set of inputs of the second modality by synthetic data generation.

3. The method according to claim 2, wherein the determining of the set of inputs of the second modality by synthetic data generation includes: (i) determining the inputs of the second modality with a generative artificial intelligence depending on the inputs of the first modality, or depending on captured data representing the movement of the body in the real world, or (ii) determining the set of inputs of the second modality in a simulation of the motion of the body.

4. The method according to claim 1, wherein the inputs of the first modality include at least one of: different digital images, or different audio sequences.

5. The method according to claim 1, wherein the inputs of the second modality include a physical quantity, the physical quantity including an acceleration of the body or velocity of the body or yaw rate of the body or pitch rate of the body or roll rate of the body, wherein one input of the second modality includes at least one value of the physical quantity.

6. The method according to claim 1, wherein the inputs of the second modality include text, wherein the text in a respective input of the second modality describes a position or part of the motion of the body that the respective input represents.

7. The method according to claim 6, further comprising:
providing a signal characterizing the movement of the body, the signal including the first modality;
providing a target pattern for the signal; and
providing a label associated with the target pattern;
wherein the determining the text includes matching a pattern of the signal to the target pattern, and
determining the text to include the label.

8. A device for multi-modal foundation model training, the device comprising:
at least one processor; and
at least one non-transitory memory storing instructions for multi-modal foundation model training, the instructions, when executed by the at least one processor, causing the device to perform the following steps including:
providing a set of inputs of a first modality and a set of inputs of a second modality, wherein the set of inputs of the first modality includes a sequence of the inputs of the first modality representing a movement of a body in the real world, and wherein the set of inputs of the second modality includes a sequence of the inputs of the second modality representing the same movement of the body in the real world,
determining for inputs to the multi-modal foundation model includes for each of different combinations of one input of the set of inputs of the first modality and one input of the set of inputs of the second modality, a respective output of the multi-modal foundation model respectively, and
training the multi-modal foundation model depending on a loss that includes a respective weighted loss term for each of the outputs.

9. A non-transitory computer-readable storage medium on which is stored a computer program including computer-readable instructions that, when executed by a computer, cause the computer to perform the following steps comprising:
providing a set of inputs of a first modality and a set of inputs of a second modality, wherein the set of inputs of the first modality includes a sequence of the inputs of the first modality representing a movement of a body in the real world, and wherein the set of inputs of the second modality includes a sequence of the inputs of the second modality representing the same movement of the body in the real world;
determining for inputs to the multi-modal foundation model includes for each of different combinations of one input of the set of inputs of the first modality and one input of the set of inputs of the second modality, a respective output of the multi-modal foundation model respectively; and
training the multi-modal foundation model depending on a loss that includes a respective weighted loss term for each of the outputs.
